(19) United States
(12) Patent Application Publication
(10) Pub. No.: US 2014/0101064 A1
(43) Pub. Date: Apr. 10, 2014

(54) Systems and Methods for Automated Reprogramming of Displayed Content

(71) Applicants: Scott Bedard, San Carlos, CA (US); Ankarino Lara, Pasadena, CA (US); Vince Broady, Santa Monica, CA (US)

(72) Inventors: Scott Bedard, San Carlos, CA (US); Ankarino Lara, Pasadena, CA (US); Vince Broady, Santa Monica, CA (US)

(21) Appl. No.: 13/644,389

(22) Filed: Oct. 4, 2012

(51) Int. Cl. G06Q 50/00

(52) U.S. Cl. CPC G06Q 50/01
USPC 705/319

(57) ABSTRACT

The present invention relates to systems and methods for autonomously reprogramming displayed content. A desired result is identified. A psychological profile is accessed for the user. The psychological profile includes a persistent user identification which enables access to the profile across a wide range of content providers. The persistent user identification is stored locally with the user as a cookie, and is associated with usernames the user has for each content provider. Content is selected for by maximizing probabilities of the desired result occurring based upon the psychological profile. The content is then provided to the content provider, and feedback is collected. This feedback is used to update the psychological profile. If the feedback is negative, the system may re-select content by maximizing the probability of the desired result occurring based upon the updated psychological profile.

### BACKGROUND

The present invention relates to systems and methods for automated reprogramming of displayed content to a user. Such systems and methods are particularly useful in the context of online activities, and may be especially useful in social media. Such systems and methods enable website providers to rapidly generate preferable content for the user. This content may include advertisements which the user is particularly susceptible to, or non-advertisement content tailored to maintain the user's interest.

Content tailoring to a user is not a new concept. By presenting a user what they want to see, it is easier to engage the user and particularly in the context of advertising, generate greater sales activity. As such, companies have invested large amounts of resources to tailor content to users. In published or broadcasted media, where content granularity on a user-by-user basis is not readily possible, companies spare no effort in determining the target demographic and ensuring their content matches the user's interests. Advertisements on a children's television network are specifically tailored to the age and gender of children most likely to be viewing the program. These advertisements differ greatly from late night ads that cater to a more mature audience.

This phenomenon of content tailoring is not unique to television; just about every media available rigorously selects content to be the most appealing to the target audience. However, in the past, most media was not granular to a particular user. Television, radio and most printed media is widely distributed to a number of users. Companies attempting to engage users must rely upon aggregate user demographic data in order to select content. As a result, content provided to users seldom caters toward specialty interests, or specifics. For example, while Macy's may run a television advertisement regarding a sale that mentions a number of broad product categories, it is very rare to dedicate an entire advertisement to a specific product that only a small number of users would be interested in.

With the increasing dominance of the internet, however, this model started to become obsolete. In an online environment it is possible to cater each piece of content to the individual user. Thus even if two users go to the same webpage, it is possible to display different content to each user based upon their preferences.

Large search engines were among the first companies to capitalize on presenting users tailored content. When a user types in a search string into Google search engine, for example, the webpage displayed includes not only the results of the search, but also advertisements that are deemed to be relevant to the user based upon the search.

In time, other websites adopted mechanisms to provide tailored content to users. Amazon, for example, knows the user's purchase history and may provide recommended purchases to the user. Netflix compiles suggested content to the user based upon reviews the user inputs regarding content they have already experienced. Other websites track the user's online activities via cookies, and use the browsing history to generate advertisements. For example, if a user goes to Disney's website and looks into ticket and hotel pricing, and later goes to a news website, the advertisements on the news website may include offers for Disney vacations.

By tailoring content to the user, these content providers increase the likelihood that a user will stay on the website longer, and moreover, engage in commercial activity by taking advantage of an offer or advertisement. However, while content tailoring has improved due to granularity and better analytics, it isn't until relatively recently that content has been selected by mining a user's sentiments in order to generate content in line with the user's preferences.

Increasingly, users are providing rich feedback online as to their personalities, likes and dislikes, and preferences. Particularly in social networks, users are volunteering enormous amounts of information about themselves that can be utilized by content providers in order to generate highly relevant content for the user. “Sentiment analysis” of user comments, reviews and activities online is described in US patent publication 2012/0101808, for example.

While content tailoring based upon analysis of the user's online comments is known, these systems have the drawback of being linked to a particular user, within a particular content provider's system. For example, a particular social network may analyze users' sentiment in order to provide relevant advertisements, but is entirely unaware of the users' other activities. This can cause a skewing of what the system perceives about the user, and thus may cause less relevant content to be provided to the user. Additionally, if a user is an infrequent contributor in the content provider's system, insufficient data may be developed about the user in order to effectively tailor content to that user.

It is therefore apparent that an urgent need exists for an improved system for reprogramming displayed content in an autonomous manner. Such systems and methods would be able to collect user data from a wide variety of sources and thereby generate a more robust profile of the user. This profile may them be employed across various platforms in order to update content provided to the user in a rapid and accurate manner.

### SUMMARY

To achieve the foregoing and in accordance with the present invention, systems and methods for automated reprogramming of displayed content is provided. Such systems and methods enable content to be chosen for a user that is more likely to achieve a desired result. This results in a more engaging experience for the user, increased revenue for retailers, and greater popularity of content providers.

In some embodiments, the automated reprogramming system identifies a desired result. The desired result includes sharing of the content, making a purchase, broadcasting the content, or building up reputation of the content. The system then accesses a psychological profile for the user. The psychological profile may include the user's sentiments, interests, and demographics, state of mind, habits, and networks. The psychological profile also includes a persistent user identification which enables access to the psychological profile across a wide range of content providers. The persistent user identification is stored locally with the user as a cookie, and is associated with usernames the user has for each content provider. The content providers may include any of social networks, blogs, media sources, news outlets, and retailers.

Next, the system selects content by maximizing probabilities of the desired result occurring based upon the psychological profile. The content is then provided to the content provider. The system then collects feedback in relation to the content. This feedback is used to update the psychological profile. If the feedback is negative, the system may re-select content by maximizing the probability of the desired result occurring based upon the updated psychological profile.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram illustrating users engaging content providers in conjunction with an automated reprogramming system to tailor content displayed to the users, in accordance with some embodiments;

FIG. 2 is an example block diagram for the automated reprogramming system, in accordance with some embodiments;

FIG. 3 is an example flow chart for the process of generating tailored content for a user by employing the automated reprogramming system, in accordance with some embodiments;

FIG. 4 is an is an example flow chart for the process of content selection, in accordance with some embodiments;

FIG. 5 is an example flow chart for the process of feedback analysis, in accordance with some embodiments;

FIG. 6 is an example screenshot of a content provider's webpage in which the automated reprogramming system may be employed, in accordance with some embodiments; and

FIGS. 7A and 7B are example illustrations for computer systems configured to embody the automated reprogramming system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to a novel and improved means, systems and methods for providing automated reprogramming of a content display in order to present users with content that is best suited to them. These systems and methods may be particularly useful within social media settings, where user data is rich, but may be extended to any content provider. Additionally, the following systems and methods are reliant upon content being unicast to the user, as opposed to broadcasted content.

Note that while much of the discussion contained herein relates to content providers over the internet, it is possible that alternate system and methods may be employed within any content distribution framework, as long as the content provided to each user may be granularly selected for said user. As such, any network that allows users to access specific data may employ the following systems and methods.

Further, while much of the following discussion will center around social networks providing content to the users, it is entirely possible that any content provider may utilize the disclosed systems and methods. As long as the user can be linked to an individualized profile by the disclosed system, it is possible to implement content reprogramming as disclosed herein in a wide range of websites. For example, media sources, such as YouTube, news outlets, such as CNN online, and online retailers, such as Amazon, may all be considered “content providers” for the purposes of this disclosure.

Lastly, while the term “content” is commonly utilized in this disclosure to mean advertisements, promotions or offers (monetization vehicles), it is entirely possible that content may include non-advertisement content. It may be desirable to capture the user's interest for as long as possible, since many websites are valued based upon user traffic. By tailoring content displayed upon the website to the user, they may spend more time on the particular site without the desire to navigate away from the content provider.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Automated Reprogramming System

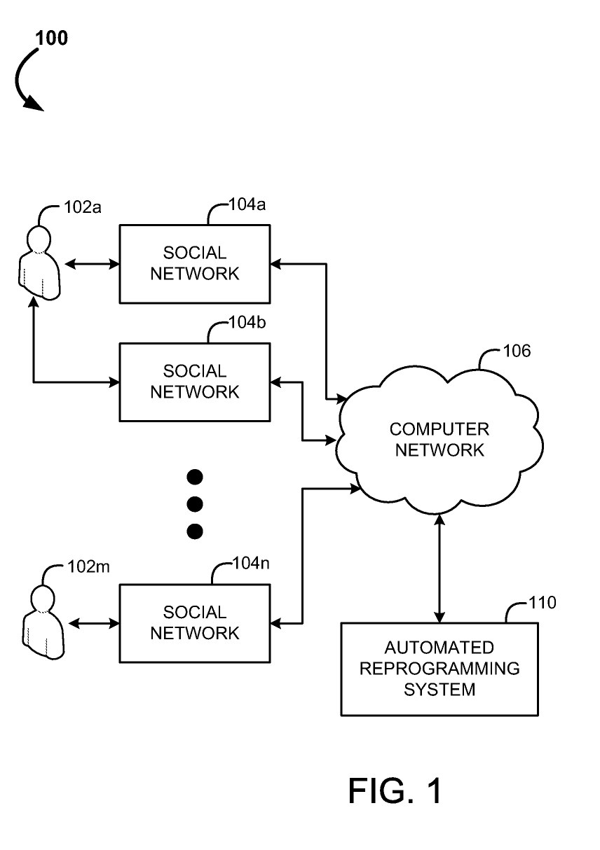

To facilitate the discussion, FIG. 1 is an example functional block diagram 100 illustrating users 102a to 102m engaging content providers in conjunction with an automated reprogramming system to tailor the content displayed. In this particular example illustration, two users 102a to 102m are seen interacting with one or more social networks 104a to 104n. While social networks 104a to 104n are illustrated in this example illustration, it is considered within the scope of this disclosure that any content provider may be accessed by the users 102a to 102m, including entertainment sites, news outlets, retailers, search engines, blogs, informational and reference pages, websites for organizations, or any other provider of content to a user.

The social networks 104a to 104n are accessed by the users 102a to 102m via a computer network 106. In some embodiments, the computer network 106 is the internet; however, it is possible that the computer network 106 may include any wide area network, local area network, company network, intelligent television network, etc. The computer network 106 additionally couples the social networks 104a to 104n to an automated reprogramming system 110.

In some embodiments, a user 102a may access a social network 104a. The social network 104a provides content to the user 102a. In some cases, the content provided to the user 102a may be selected by the automated reprogramming system 110 which operates in the background to analyze the sentiments of the user 102a. Unlike current systems, the automated reprogramming system 110 is capable of tying each user 102a to a persistent identification, stored within the automated reprogramming system 110 and linked to the user's 102a identification in each content provider they frequent. This persistent identification allows the sentiment of the user 102a to be tracked across various social networks 104a to 104n (or other content providers). This enables the automated reprogramming system 110 to learn about the user 102a, develop a personality profile, and make more exact predictions regarding how the user 102a will react to any particular content.

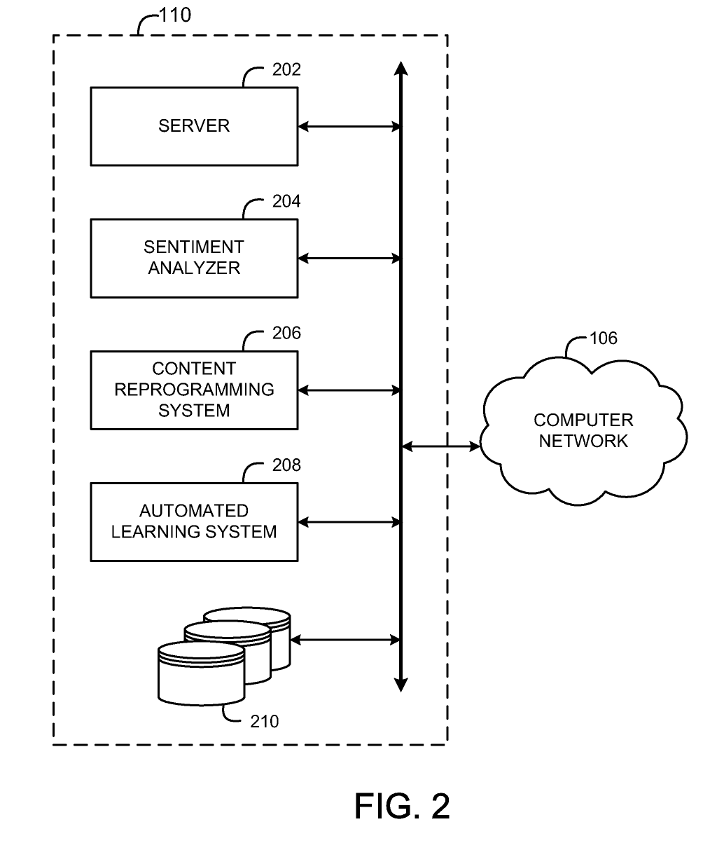

FIG. 2 is an example block diagram for the automated reprogramming system 110, in accordance with some embodiments. The automated reprogramming system 110 includes a server 202, a sentiment analyzer 204, a content reprogramming system 206, an automated learning system 208, and a database 210. Each of these subsystems are logical components of the automated reprogramming system 110 and are logically coupled to one another. In cases where these subsystems are embodied upon a single device, or operating within a cloud environment, the coupling may be merely logical in nature. When these subsystems are embodied within separate devices, the coupling may include a physical connection, such as a central bus.

Each component of the automated reprogramming system 110 may likewise access the computer network 106. The server 202 may interact directly with the social networks 104a to 104n (or other content providers) in order to provide the content selection for a given user 102a. A profile for the user 102a may be employed by the sentiment analyzer 204 in order to generate probabilities that the given user 102a will react positively to a given piece of content. The profiles and available content may be stored within the database 210.

The content reprogramming system 206 may take the selected content and reprogram the social network 104a to include the content. This may include formatting the content in a manner acceptable to the social network 104a. The automated learning system 208 may analyze feedback provided by the user 102a in order to populate or update that individual's profile. This “learning” element to the automated reprogramming system 110 may occur across multiple social networks 104a to 104n and other content providers, thereby providing the automated reprogramming system 110 unprecedented opportunities to develop a rich dataset regarding the user 102a.

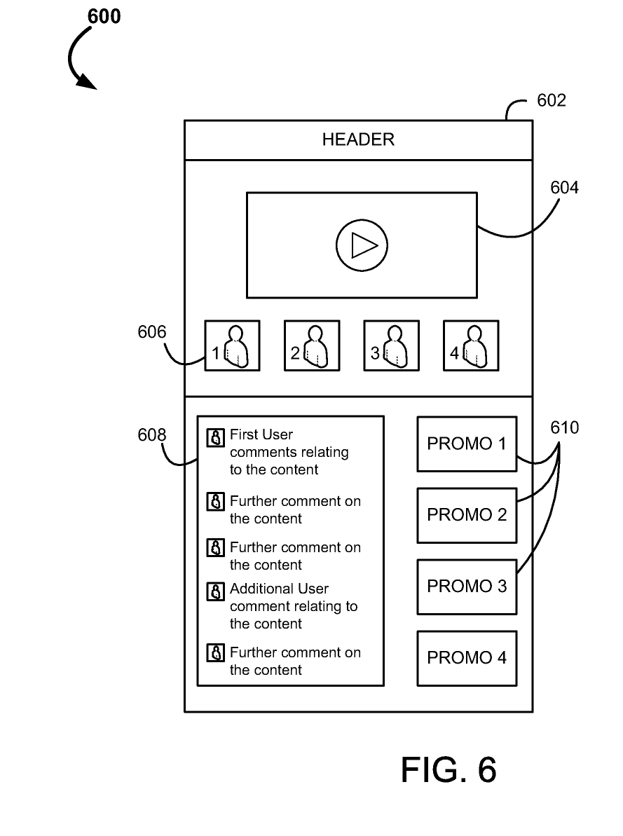

FIG. 6 is an example screenshot 600 of a content provider's webpage in which the automated reprogramming system may be employed, in accordance with some embodiments. In this example screenshot, a header 602 is displayed, below which a primary content 604 is presented. Alternate content 610 is highlighted in a sidebar in this example. This example screen also includes a comments section 606. The users are displayed in thumbnails 608. The system logs the users' activity on the page. In some embodiments, a table of activities may be generated in the following format:

| | | Content | | | | | |
|---|---|---|---|---|---|---|---|
| Us- | | De- | User | | | | |
| er | Date/ | scrip- | Ac- | | Facebook | | Twitter |
| ID | Time | tion | tion | Object | ID | • • • | ID |
| 1 | 9-13 | Brand 1 | Media | 2 | Stacy2012 | • • • | |
| | 11:00 | | View | | | | |
| 1 | 9-14 | Brand 1 | Com- | Stop | | • • • | Smiller8 |
| | 12:32 | | ment | testing | | | |
| | | | | on | | | |
| | | | | animals | | | |
| 1 | 9-14 | Brand 2 | Show | 4 | Stacy2012 | • • • | |
| | 2:43 | | times | | | | |
| 2 | 8-29 | Brand 1 | Media | 2 | MerryMan | • • • | |
| | 9:02 | | View | | | | |

As can be seen in the example table, each user is given a user ID (persistent identification) that is independent from other content provider IDs. While the table is illustrated as including Facebook and Twitter, typical data sets will include a very large number of content providers, where the user's ID can be associated with an ID native to each content provider.

Using this example table's dataset, a user ID number 1 was recorded viewing a Brand 1 media clip on September 13^{th} on her Facebook account. The same user then posted a comment on Twitter on September 14 stating “Stop testing on animals.” Sentiment analysis on the comment determines that this user has reacted badly to the content displayed on Facebook, and alternate content may be selected for display to the user. This sentiment analysis may be performed upon subsequent page loading, or may be performed instantly once a negative sentiment is received. In this way, it may be possible to replace offending content as rapidly as possible in order to protect the advertisers, and also to maintain user satisfaction. Below the process for reprogramming content on the social networks 104a to 104n, and other content providers, will be described in greater detail.

### II. Automated Reprogramming Process

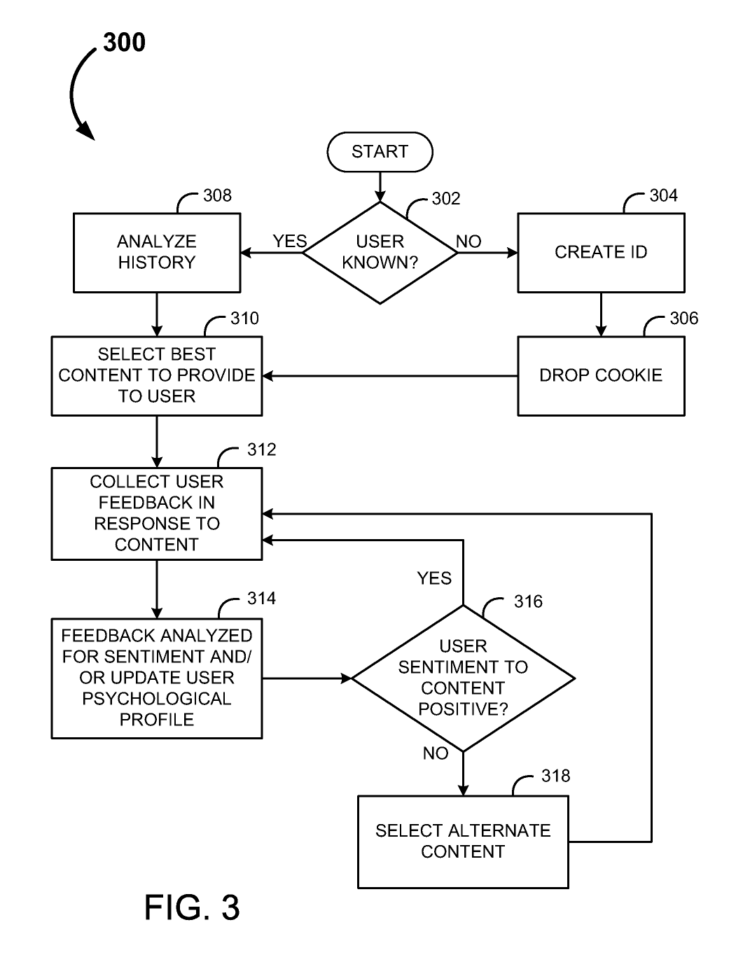

FIG. 3 is an example flow chart 300 for the process of generating tailored content for a user by employing the automated reprogramming system, in accordance with some embodiments. In this example process, initially a decision is made whether the user accessing the content provider is known (at 302). Users are “known” when they can be tied to a psychological profile. The automated reprogramming system may identify tracking cookies upon the user's computer (or other computational device, such as tablets, mobile devices, etc.). If no identifying cookie exists, some embodiments of the automated reprogramming system may alternatively identify the user by device MAC address or other indication. In some embodiments, the user is known if she is logged into the content provider. For example, a user must supply a password and username to access their profile in Facebook or Twitter. The content provider can use this authentication process in order to inform the automated reprogramming system of the user's identity. By leveraging both login data and cookies, the automated reprogramming system may be able to track users even when they are using different devices, and across different unrelated content provider websites.

If the user is known, the user's history is analyzed (at 308). History analysis may include accessing the user's psychological profile from storage. Alternatively, if the user is not known, an ID may be generated for the user (at 304) which is associated with a new user psychological profile. The new psychological profile may be blank initially, or may include one of potentially several default profiles based upon “stereotypical” users that access the content provider, or otherwise based upon the user's activity. After the user ID is generated, the automated reprogramming system may drop a cookie (at 306) in order to facilitate tracking the user across various content providers (such as Twitter and Facebook, for example).

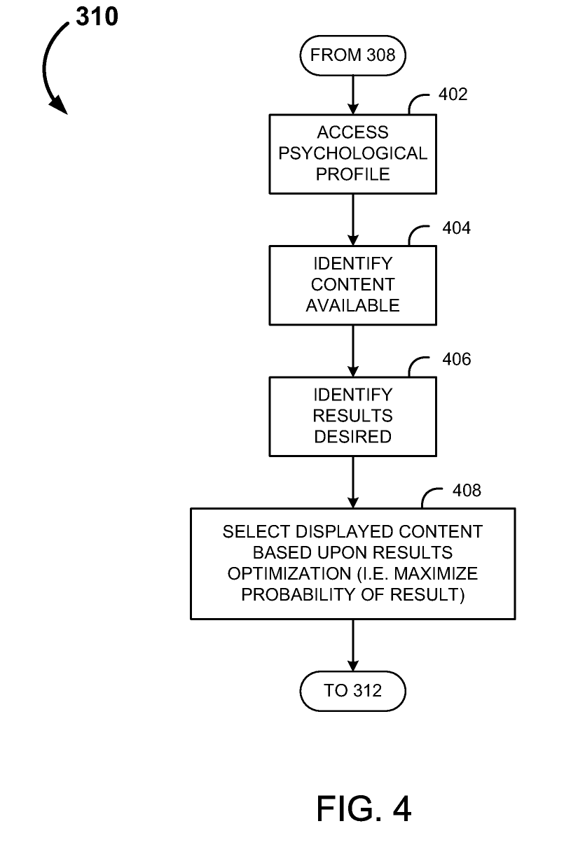

Once the psychological profile has been retrieved from storage (or newly generated), the system selects the best content to provide to the user (at 310). Turning to FIG. 4, an example flow chart for this sub process of content selection is illustrated. This process accesses the user's psychological profile (at 402). The psychological profile may include any number of variables that can be utilized to model user response to content. Typically, a psychological profile may include sentiments, interests, demographics, state of mind, habits, and networks, for example. Sentiments may indicate an overall personality such as “negative”, or “optimistic”. Interests may include topics the user is interested in, such as “movies”, “fashion” or “food”. Demographics may include information such as age, race, gender, and socioeconomics. State of mind may include overarching themes the user is involved in, such as “getting married”, “having a baby”, “buying a house” or other such life events that are persistently impacting the user. Habits may include behavioral habits such as being a “purchaser” or “sharer”. Network may include the user's friend lists and other contacts.

The automated reprogramming system also queries the database for the content that is available for display to the user (at 404). The desired result is then determined by the system (at 406). The desired result, in the case of an advertisement, may include the user clicking upon the ad, or accessing the website that the advertisement is promoting. If the content is non-advertisement material, the desired result may include staying longer on the webpage, or exploring the content in greater detail. Other desirable results may include sharing of the content, making a purchase, broadcasting the content, or building up reputation of the content (typically through positive comments).

Once the system identifies which result is desired, it then models the probability of that result occurring for each of the available content based upon the user profile (at 408). This modeling may compare how other users with similar psychological profiles reacted to the content in order to build a probability function where each category in the psychological profile is a variable. The system may then optimize for the largest probability of the result occurring, given the available content. The identified content may be selected for display. In some embodiments, vector similarity may be employed to match the user profile to content. Content may be recommended via user-item collaborative filtering. Recommendations obtained from both content similarity and collaborative filtering may then be ranked using weights calculated from feedback and displayed to user, in some embodiments. Users may also be matched to one another using vector similarity, or comparable analytic techniques.

Returning to FIG. 3, once the content has been selected and displayed, the system collects feedback from the user (at 312) in response to the content. This feedback may include a comment, a desired result, or some other action by the user. The feedback may be analyzed for sentiment and the user's psychological profile may be updated (at 314).

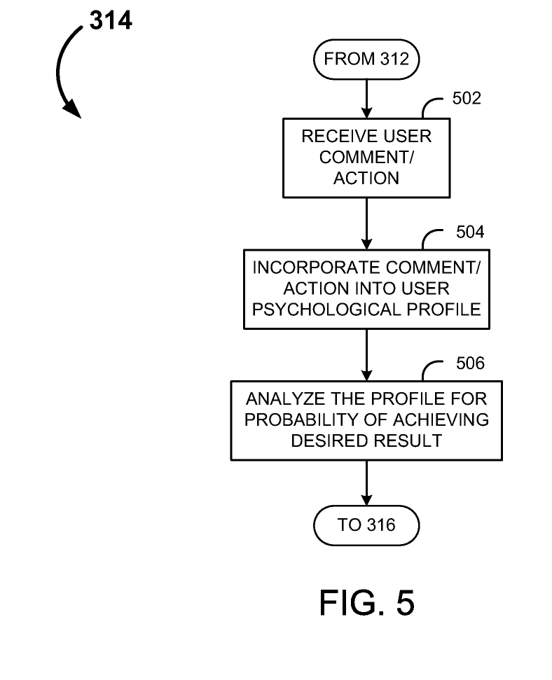

Turning now to FIG. 5, an example flow chart for the process of feedback analysis is illustrated. In this example process, the user's comment or action is received (at 502), and the comment or action is incorporated into the user psychological profile (at 504). For example, assume the user provides feedback to content including a comment of “Stop testing on animals”. The system may parse the comment, and perform syntactical analysis on the parsed comment. Based upon the analysis, the system may determine that changing the content is appropriate. It may also be possible that the comment may be analyzed for factual accuracy, and if inaccurate, content illustrating facts may be presented. For example, assume the brand being commented upon does not do animal testing. The system may then provide the user with a video illustrating how testing is performed in order to alter the negative opinion the user has of the brand. Similarly, if the comment was a question, such as “How do I do x?”, the system may provide videos or other content around that function. In a third example, the user states “I love this product.” In response, the system may provide content of the next version of the product. Conversely, if the user states “I hate this product”, the system may instead provide content of the product (or brand's) best feature. It is possible to analyze for Sentiment, Content and Context to build the profile and display appropriate content.

After the profile has been updated, it is again analyzed for the probability of achieving the desired result (at 506) in a manner similar to that discussed above. Returning to FIG. 3, the system determines if the user's sentiment is positive (at 316), and if so, maintains the content and awaits further user feedback. However, if the user reacts negatively to the content, then the system may select alternative content (at 318) using the updated psychological profile and probabilities.

In this manner, the system may build out a robust psychological profile for the user and leverage the profile to maximize the chance that content will have a desired result. If the system receives a negative feedback from the user, the profile is updated, and the content reviewed for alternatives. This ensures the user is consistently provided relevant and desirable content.

Further, by utilizing a cookie tied to the user's ID, the system is able to track the user across different content providers' platforms. Thus, comments on a Facebook page may bolster the user's psychological profile and alter the content the user may experience on an entirely different portal, such as YouTube.

### III. System Embodiments

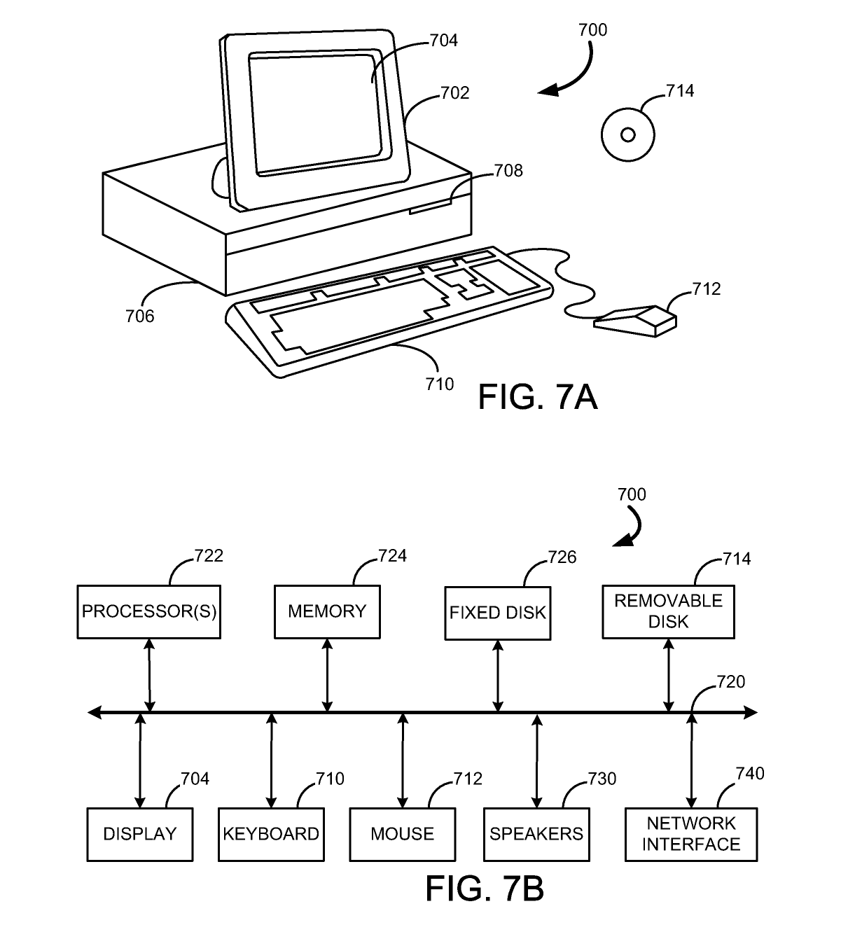

FIGS. 7A and 7B illustrate a Computer System 700, which is suitable for implementing embodiments of the present invention. FIG. 7A shows one possible physical form of the Computer System 700. Of course, the Computer System 700 may have many physical forms ranging from a printed circuit board, an integrated circuit, and a small handheld device up to a huge super computer. Computer system 700 may include a Monitor 702, a Display 704, a Housing 706, a Disk Drive 708, a Keyboard 710, and a Mouse 712. Disk 714 is a computer-readable medium used to transfer data to and from Computer System 700.

FIG. 7B is an example of a block diagram for Computer System 700. Attached to System Bus 720 are a wide variety of subsystems. Processor(s) 722 (also referred to as central processing units, or CPUs) are coupled to storage devices, including Memory 724. Memory 724 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 726 may also be coupled bi-directionally to the Processor 722; it provides additional data storage capacity and may also include any of the computer-readable media described below. Fixed Disk 726 may be used to store programs, data, and the like and is typically a secondary storage medium (such as a hard disk) that is slower than primary storage. It will be appreciated that the information retained within Fixed Disk 726 may, in appropriate cases, be incorporated in standard fashion as virtual memory in Memory 724. Removable Disk 714 may take the form of any of the computer-readable media described below.

Processor 722 is also coupled to a variety of input/output devices, such as Display 704, Keyboard 710, Mouse 712 and Speakers 730. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor 722 optionally may be coupled to another computer or telecommunications network using Network Interface 740. With such a Network Interface 740, it is contemplated that the Processor 722 might receive information from the network, or might output information to the network in the course of performing the above-described multi-merchant tokenization. Furthermore, method embodiments of the present invention may execute solely upon Processor 722 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present invention provides systems and methods for automated reprogramming of displayed content. Such systems and methods collect user data from a wide range of independent content providers, thereby generating a robust profile of the user. This profile may them be employed across various platforms in order to update content provided to the user in a rapid and accurate manner.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for autonomously reprogramming content on a content provider comprising:
identifying a desired result;
accessing a psychological profile that includes a persistent user identification, wherein the persistent user identification enables access to the psychological profile across a plurality of content providers; and
selecting content by maximizing probabilities of the desired result occurring based upon the psychological profile.

2. The method of claim 1, wherein the content providers include any of social networks, blogs, media sources, news outlets, and retailers.

3. The method of claim 1, further comprising providing the selected content to a content provider.

4. The method of claim 3, further comprising collecting feedback by the user to the selected content.

5. The method of claim 4, further comprising updating the psychological profile in response to the collected feedback.

6. The method of claim 5, further comprising re-selecting content by maximizing probabilities of the desired result occurring based upon the updated psychological profile.

7. The method of claim 1, wherein the psychological profile includes any of sentiments, interests, demographics, states of mind, habits, and networks.

8. The method of claim 1, wherein the persistent user identification is stored locally with the user as a cookie.

9. The method of claim 1, wherein the persistent user identification is associated with usernames the user has on each content provider.

10. The method of claim 1, wherein the desired result includes sharing of the selected content, making a purchase, broadcasting the selected content, or building up reputation of the selected content.

11. A system for autonomously reprogramming content on a content provider comprising:
a sentiment analyzer configured to:
identify a desired result;
access a psychological profile that includes a persistent user identification, wherein the persistent user identification enables access to the psychological profile across a plurality of content providers; and
select content by maximizing probabilities of the desired result occurring based upon the psychological profile.

12. The system of claim 11, wherein the content providers include any of social networks, blogs, media sources, news outlets, and retailers.

13. The system of claim 11, further comprising a server configured to provide the selected content to a content provider.

14. The system of claim 13, further comprising an automated learning system configured to collect feedback by the user to the selected content.

15. The system of claim 14, wherein the automated learning system is further configured to update the psychological profile in response to the collected feedback.

16. The system of claim 15, wherein the sentiment analyzer is further configured to re-select content by maximizing probabilities of the desired result occurring based upon the updated psychological profile.

17. The system of claim 11, wherein the psychological profile includes any of sentiments, interests, demographics, states of mind, habits, and networks.

18. The system of claim 11, wherein the persistent user identification is stored locally with the user as a cookie.

19. The system of claim 11, wherein the persistent user identification is associated with usernames the user has on each content provider.

20. The system of claim 11, wherein the desired result includes sharing of the selected content, making a purchase, broadcasting the selected content, or building up reputation of the selected content.
